(19) United States
(12) Patent Application Publication
(10) Pub. No.: US 2013/0283799 A1
(43) Pub. Date: Oct. 31, 2013

(54) RESONANCE DAMPER FOR DAMPING ACOUSTIC OSCILLATIONS FROM COMBUSTOR

(71) Applicants: Daniel W. Carey, San Diego, CA (US); Leonel O. Arellano, Poway, CA (US)

(72) Inventors: Daniel W. Carey, San Diego, CA (US); Leonel O. Arellano, Poway, CA (US)

(73) Assignee: Solar Turbines Inc., San Diego, CA (US)

(21) Appl. No.: 13/455,372

(22) Filed: Apr. 25, 2012

(51) Int. Cl. F02C 7/24; F02K 1/82; F23R 3/00

(52) U.S. Cl. 60/725; 181/213

(57) ABSTRACT

A resonance damper for damping acoustic oscillations within a combustor housing of a gas turbine engine is provided. The resonance damper includes a container, an opening, and a pipe. The container is configured to be attached to an interior wall of the combustor housing and has a cavity. The opening is provided on the container. The pipe is rigidly connected to the opening to define the resonance damper with the cavity.

### TECHNICAL FIELD

The present disclosure relates to a resonance damper for damping acoustic oscillations, and more particularly to a resonance damper for damping acoustic oscillations within a combustor housing of a gas turbine engine.

### BACKGROUND

A resonance damper is provided in a gas turbine engine to damp acoustic oscillations produced by components within the engine thus avoiding detrimental effects to the service and life of the gas turbine engine. U.S. Pat. No. 7,076,956 relates to a combustion chamber suitable for a gas turbine engine. The combustion chamber is provided with at least one Helmholtz resonator having a resonator cavity and a damping tube in flow communication with the chamber interior. The damping tube is provided with at least one cooling hole extending through its wall.

### SUMMARY

In one aspect, the present disclosure provides a resonance damper for damping acoustic oscillations within a combustor housing of a gas turbine engine. The resonance damper includes a container, an opening, and a pipe. The container is configured to be attached to an interior wall of the combustor housing and has a cavity. The opening is provided on the container. The pipe is rigidly connected to the opening to define the resonance damper with the cavity.

In another aspect, the present disclosure provides a combustor housing of a gas turbine engine. The combustor housing includes a combustor and the resonance damper for damping the acoustic oscillations within the combustor housing. The combustor produces the acoustic oscillations. The resonance damper includes the container, the opening, and the pipe. The container is configured to be attached to the interior wall of the combustor housing and has the cavity. The opening is provided on the container. The pipe is rigidly connected to the opening to define the resonance damper with the cavity.

In another aspect, the present disclosure provides a gas turbine engine including a compressor system, multiple injectors, and the combustor housing. The injectors are adapted to receive compressed air from the compressor system. The injectors are further adapted to premix and supply fuel and air. The combustor housing includes the combustor and the resonance damper for damping the acoustic oscillations within the combustor housing. The combustor is operatively connected to the injectors. The combustor is configured to receive and combust the premixed fuel and air thereby producing acoustic oscillations. The resonance damper includes the container, the opening, and the pipe. The container is configured to be attached to the interior wall of the combustor housing and has the cavity. The opening is provided on the container. The pipe is rigidly connected to the opening to define the resonance damper with the cavity.

Other features and aspects of this disclosure will be apparent from the following description and the accompanying drawings.

### BRIEF DESCRIPTION OF THE DRAWINGS

FIG. 1 is a sectional view of a gas turbine engine in accordance with an embodiment of the present disclosure;

FIG. 2 is a sectional view of a combustor housing of the gas turbine engine of FIG. 1;

FIG. 3 is a front view of a resonance damper; and

FIG. 4 is a side view of the resonance damper of FIG. 3.

### DETAILED DESCRIPTION

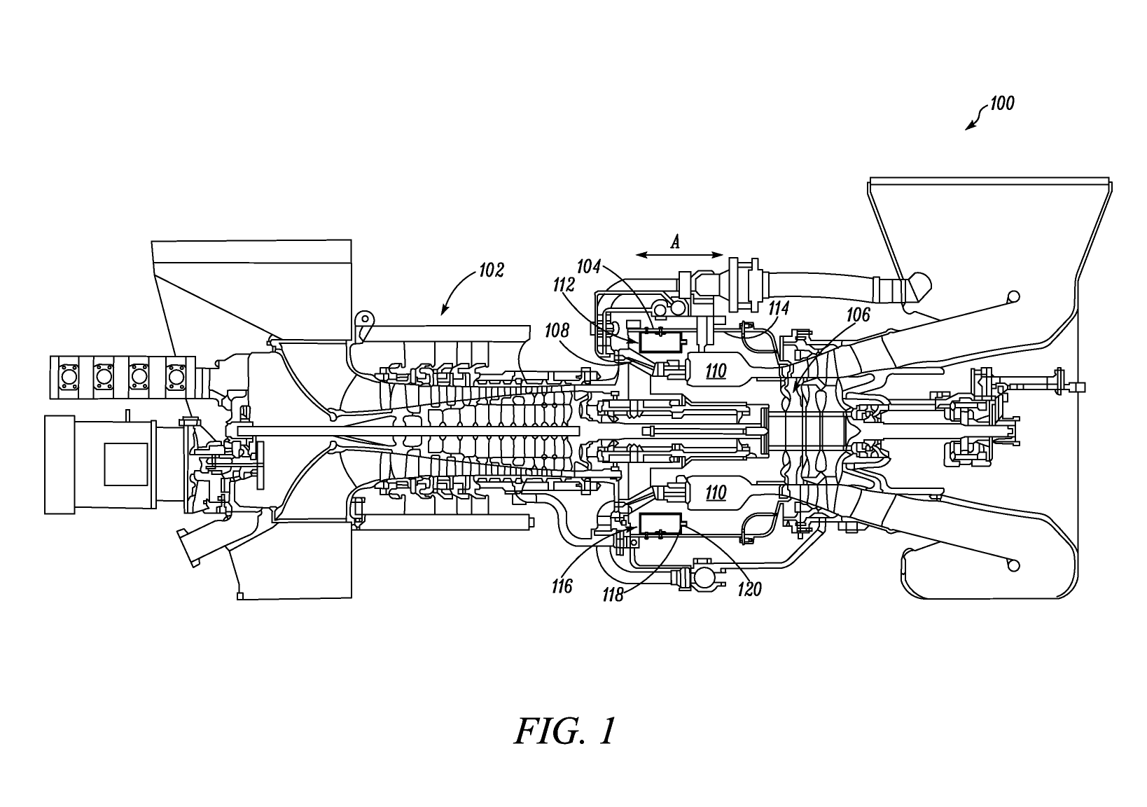

The present disclosure relates to a resonance damper for damping acoustic oscillations within a combustor housing of a gas turbine engine. FIG. 1 shows a sectional view of a gas turbine engine 100 in which disclosed embodiments may be implemented. The gas turbine engine 100 may be of any type. In one embodiment, the gas turbine engine 100 may be an industrial turbine engine, for example, but not limited to, an axial flow turbine used for power generation or driving mechanical assemblies, or in jet propulsion systems. As shown in FIG. 1, the gas turbine engine 100 may embody an axial flow industrial turbine which may be used for power generation.

As shown in FIG. 1, the gas turbine engine 100 includes a compressor system, a combustor housing 104, and a turbine system 106. The compressor system 102 is provided to compress air and operatively provide the compressed air to various components of the gas turbine engine 100. The compressor system 102 may be, but not limited to, a rotary compressor. Further, the compressor system 102 may be a single stage or a multistage compressor. In FIG. 1, the compressor system 102 may embody a multistage rotary compressor. The gas turbine engine 100 further includes multiple injectors 108 adapted to receive compressed air from the compressor system 102. Further, the injectors 108 may be adapted to supply a mixture of fuel and air.

Further, as shown in FIG. 1, the combustor housing 104 includes a combustor 110 and a resonance damper 112. The combustor 110 is disposed within the combustor housing 104 of the gas turbine engine 100 and is operatively connected to multiple injectors 108. The injectors 108 supply the mixture of fuel and air to the combustor 110. The combustor 110 receives and combusts the mixture of fuel and air to generate energy. This energy may be utilized to drive the turbine system 106 which may in turn use some part of the energy in driving the compressor system 102 while concurrently using the remaining part of the energy to do work. During combustion of the mixture of fuel and air by the combustor 110, some of the energy is released in the form of acoustic energy. This acoustic energy may be manifested as acoustic oscillations in an axial, circumferential, or other mode shape within the combustor housing 104 as is known to persons having ordinary skill in the art.

The acoustic oscillations radiating from the combustor 110 reflect away from interior walls 114 of the combustor housing 104 thus moving successively to and fro within the combustor housing 104. There is a possibility that two or more acoustic oscillations may undergo constructive interference thus increasing the amplitude of the resulting acoustic oscillation, also known as, dynamic pressure oscillation.

Further, as shown in FIG. 1, the resonance damper 112 includes a container 116, an opening 118, and a pipe 120. The resonance damper 112 is configured to damp the acoustic oscillations within the combustor housing 104. In one embodiment, the resonance damper 112 is configured to damp the acoustic oscillations travelling in an axial direction A within the combustor housing 104.

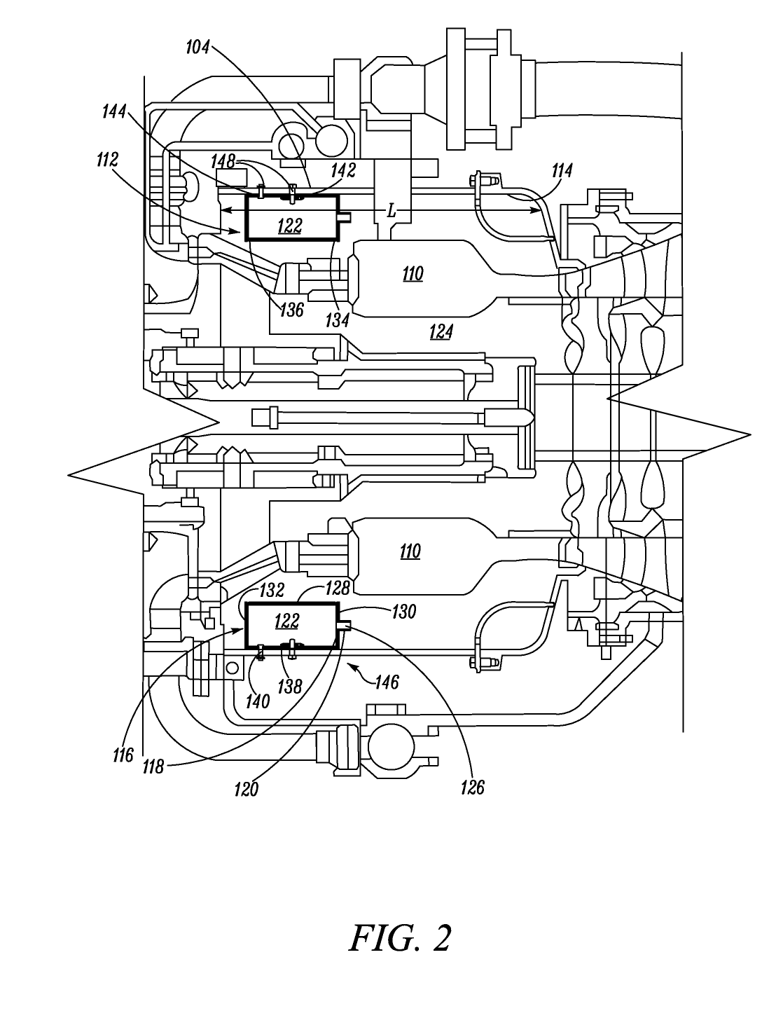

FIG. 2 shows a sectional view of the combustor housing 104 present in the gas turbine engine 100. The container 116 is configured to be attached to the interior wall 114 of the combustor housing 104. The container 116 has a cavity 122.

In one embodiment, the resonance damper 112 is positioned in a predetermined region of maximum dynamic pressure fluctuations within the combustor housing 104. In this embodiment, the extent of length L of the combustor housing 104, at which the resonance damper 112 is positioned, may be decided based on predetermined calculations that show a region in the combustor housing 104 where the dynamic pressure fluctuations are substantially. Further, the position of the resonance damper 112 is selected based on a pre-determined mode shape of the acoustic oscillations or dynamic pressure fluctuations within the combustor housing 104. Furthermore, a number of such resonance dampers 112 may be provided within the combustor housing 104 depending on the amount of resonance damping required. The number of resonance dampers 112 may be selected such that the required amount of resonance damping is achieved by providing an optimal amount of acoustic connectivity between an interior 124 of the combustor housing 104 and the respective cavities 122.

Further, as shown in FIG. 2, the opening 118 is provided on the container 116 and the pipe 120 is rigidly connected to the opening 118 to define the resonance damper 112 with the cavity 122. In an embodiment, the pipe 120 may be rigidly connected to the opening 118 by welding. Further, the pipe 120 defines a throat 126 configured to allow passage of the acoustic oscillations into the cavity 122.

In an embodiment as shown in FIG. 2, the container 116 includes a hollow tube 128, a front plate 130, and a back plate 132. The front plate 130 and the back plate 132 are rigidly connected to opposing ends 134, 136 of the hollow tube 128. In an embodiment, the front plate 130 and the back plate 132 are rigidly connected to opposing ends 134, 136 of the hollow tube 128 by welding.

In the preceding embodiments, it is disclosed that the pipe 120 is rigidly connected to the opening 118 by welding and that the front plate 130 and the back plate 132 are rigidly connected to opposing ends 134, 136 of the hollow tube 128 by welding. However, a person having ordinary skill in the art will appreciate that the rigid connection of the pipe 120 to the opening 118, and the front and the back plate 130, 132 to the opposing ends 134, 136 of the hollow tube 128 by welding, is only exemplary in nature and that any other method known in the art may be used to accomplish these rigid connections.

In the embodiment as shown in FIG. 2, the container 116 further includes a nut 138 and a clevis pin 140 rigidly connected to the hollow tube 128 at a first opening 142 and a second opening 144 respectively. The container 116 is configured to be attached to the interior wall 114, at an anterior portion 146 of the combustor housing 104 by fasteners 148. The fastener 148 may be, for example, a threaded bolt configured to be bolted through the nut 138 rigidly connected to the hollow tube 128 at a first opening 142. Further, another type of fastener 148 may be a split pin configured to secure a position of the hollow tube 128 with respect to the combustor housing 104 by connecting to the clevis pin 140. During operation of the gas turbine engine 100, vibrations are produced by the combustor 110. These vibrations may produce a force that unscrews the hollow tube 128 from the combustor housing 104. Hence, the split pin, when used in conjunction with the bolt ensures that the hollow tube 128 does not rotate itself about the bolt under the influence of the vibrations and detaches itself from the combustor housing 104. However, a person having ordinary skill in the art will appreciate that the attachment of the container 116 to the interior wall 114, at the anterior portion 146 of the combustor housing 104 by the bolt and the split pin is only exemplary in nature and that any other method known in the art may be used to attach the container 116 to the interior wall 114 of the combustor housing 104 while ensuring that the container 116 is securely connected to the combustor housing 104.

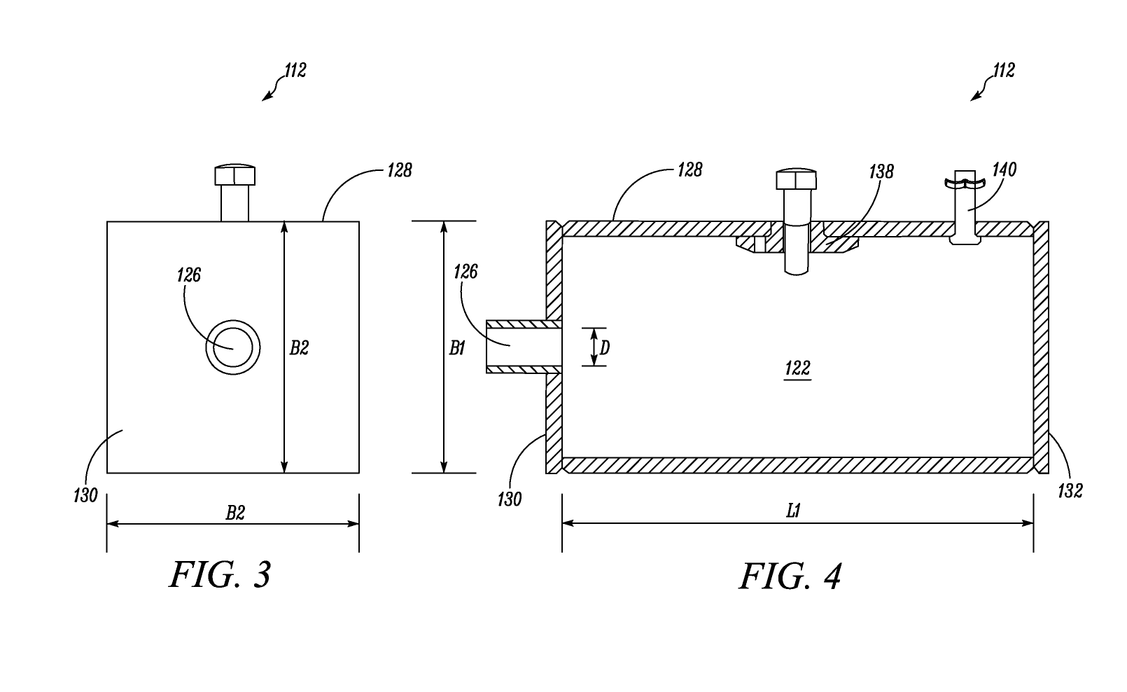

In an embodiment as shown in FIG. 3, a cross section of the hollow tube 128 is substantially square. Typically, the cross section of the hollow tube 128 is selected based on design constraints of the combustor housing 104. Further, the cross section of the hollow tube 128 may be chosen such that the hollow tube 128 together with the front and the back plate 130, 132, defines the cavity 122. As understood by a person having ordinary skill in the art, various constraints in the cross section of the hollow tube 128 stem from the objective of achieving maximum damping efficiency while meeting design constraints and space limitations within the combustor housing 104. However, a person having ordinary skill in the art will appreciate that the cross section of the hollow tube 128 being substantially square is only exemplary in nature and that any other suitable cross section such as circular cross-section may be used to form the hollow tube 128.

In an exemplary embodiment as shown in FIGS. 3 and 4, the container 116 may include a hollow tube 128 with a square cross section having a 3 inch side-dimension B1 and length L1 of approximately 5.64 inches. Hence, the front and the back plate 130, 132, rigidly attached to the opposing ends 134, 136 of the hollow tube 128, may also be of 3 inch side-dimension B2. The pipe 120 may be rigidly attached to the opening 118 positioned on the front plate 130 of the container 116 and may define a throat 126 with a diameter D of approximately 0.45 inches. The resonance damper 112 constituted by the aforesaid dimensions of respective components may dampen acoustic oscillations in the frequency range of approximately 100-300 Hertz. However, it is to be understood that the dimensions of the respective components mentioned above are only exemplary in nature. A person having ordinary skill in the art will acknowledge that these dimensions may change depending on the constraints in design of resonance damper 112 along with the frequencies of the acoustic oscillations that require damping.

### INDUSTRIAL APPLICABILITY

When the mixture of fuel and air is combusted in the combustor 110, energy is generated. A component of this energy may be released as acoustic energy which may manifest itself in the form of acoustic oscillations. As already known to a person having ordinary skill in the art, these acoustic oscillations are a type of mechanical wave that propagate with the help of a fluid medium present within the combustor 110 and the combustor housing 104. Generally, the fluid medium present within the combustor 110 is the mixture of fuel and air while the fluid medium present within the combustor housing 104 is air.

The acoustic oscillations radiating from the combustor 110 reflect away from the interior walls 114 of the combustor housing 104 thus moving successively to and fro within the combustor housing 104. There is a possibility that two or more acoustic oscillations may undergo constructive interference thus increasing the amplitude of the resulting acoustic oscillation, also known as, dynamic pressure oscillation.

As known to a person having ordinary skill in the art, many components in the combustor housing 104 have a natural frequency of vibration. When a frequency of acoustic oscillations or dynamic pressure oscillations matches the natural frequency of any component within the combustor housing 104, the specified component may undergo vibrations and subsequently fail. Further, if the frequency of acoustic oscillations or dynamic pressure oscillations matches the natural frequency of the combustor housing 104, the combustor housing 104 itself may fail. Hence, the combustor housing 104 and the components present therein need to be protected from prolonged exposure to the acoustic oscillations or the dynamic pressure oscillations. Further, fluctuations in the amplitude of the dynamic pressure oscillations can be large enough to cause failure of the combustor housing 104 and the components present therein. Furthermore, the fluctuations in the amplitude of the dynamic pressure oscillations may, at the very least, reduce the service life of the combustor housing 104 and the components present therein, even if the frequency of the acoustic oscillation is substantially different from the natural frequency of the combustor housing 104 and the components therein. Failure of the components or the combustor housing 104 may be detrimental to the safe operation of the gas turbine engine 100 and hence, damping of acoustic oscillations or dynamic pressure oscillations to safe and acceptable limits may be required.

Further, as known to a person having ordinary skill in the art, a fluid medium, for example, air, exists in the combustor housing 104. The resonance damper 112 may be analogous to a spring mass damper system, wherein the air in the throat 126 of the resonance damper 112 acts as a mass in the spring mass damper system while the air in the cavity 122 of the resonance damper 112 acts as a spring in the spring mass damper system. Frictional forces between the air in the throat 126 and the walls of the throat 126 act to dampen the dynamic pressure oscillations outside the resonance damper 112 while the air in the cavity 122 acts as a resilient spring to phase-shift and cause destructive interference among successive dynamic pressure oscillations. Hence, dynamic pressure oscillations are effectively damped by the resonance damper 112.

In an embodiment, multiple resonance dampers 112 may be annularly arranged within the combustor housing 104 of the gas turbine engine 100. The multiple resonance dampers 112 define multiple cavities 122 and may function analogous to multiple Helmholtz resonators arranged in an annular pattern to damp the dynamic pressure oscillations within the combustor housing 104.

In another embodiment, a single annular cavity 122 may be defined by an annular resonance damper 112. Further, the annular resonance damper 112 may include several pipes 120 and throats 126 therein leading to the single annular cavity 122. The tubes 120 and throats 126 may provide acoustic connectivity between the interior 124 of the combustor housing 104 and the annular cavity 122. The resonance damper 112 of this embodiment may be used to uniformly bleed air from within the combustor housing 104 for stability control of the gas turbine engine 100.

The use of the resonance damper 112 in the gas turbine engine 100 may allow smoother operation of the gas turbine engine 100. Further, the use of resonance dampers 112 in a gas turbine engine 100 may result in lower maintenance costs by avoiding frequent repairs and replacement of components within the gas turbine engine 100 otherwise impacted by large acoustic oscillations or dynamic pressure oscillations. Furthermore, down times required for repairs and replacement of components within the gas turbine engine 100 may be reduced. Hence, the resonance damper 112 may increase overall productivity and profitability associated with the gas turbine engine 100.

Furthermore, existing combustor housing structures defining internal spaces could be used to position the resonance damper 112 within the combustor housing 104. For example, in an existing combustor housing 104 defining an internal space, the resonance damper 112 may be positioned within the combustor housing 104 while the container 116 may be attached to the interior wall 114 of the combustor housing 104. The compact construction and configuration of parts of the resonance damper 112 make it retrofittable, since existing structures and spaces can be repurposed for acoustic damping purposes. Thus, the resonance damper 112 and subsequently the gas turbine engine 100 may be quickly set up with minimal effort and modifications saving time and expense.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A resonance damper for damping acoustic oscillations within a combustor housing of a gas turbine engine, the resonance damper, comprising:
a container configured to be attached to an interior wall of the combustor housing and having a cavity;
an opening provided on the container; and
a pipe rigidly connected to the opening to define the resonance damper with the cavity.

2. The resonance damper of claim 1, wherein the container is configured to be attached to the interior wall, at an anterior portion, of the combustor housing by fasteners.

3. The resonance damper of claim 1, wherein the pipe defines a throat configured to allow passage of the acoustic oscillations into the cavity.

4. The resonance damper of claim 1, wherein the container includes a hollow tube, a front plate, and a back plate, wherein the front plate and the back plate are rigidly connected to opposing ends of the hollow tube.

5. The resonance damper of claim 4, wherein the container further includes a nut and a clevis pin rigidly connected to the hollow tube at a first opening and a second opening respectively.

6. The resonance damper of claim 4, wherein a cross section of the hollow tube is substantially square.

7. A combustor housing of a gas turbine engine comprising:
a combustor producing acoustic oscillations; and
a resonance damper for damping the acoustic oscillations within the combustor housing, the resonance damper including:
a container configured to be attached to an interior wall of the combustor housing and having a cavity;
an opening provided on the container; and
a pipe rigidly connected to the opening to define the resonance damper with the cavity.

8. The combustor housing of claim 7, wherein the resonance damper is positioned in a predetermined region of maximum dynamic pressure fluctuations within the combustor housing.

9. The combustor housing of claim 7, wherein the container is configured to be attached to the interior wall, at an anterior portion, of the combustor housing by fasteners.

10. The combustor housing of claim 7, wherein the pipe defines a throat configured to allow passage of the acoustic oscillations into the cavity.

11. The combustor housing of claim 7, wherein the container includes a hollow tube, a front plate, and a back plate, wherein the front plate and the back plate are rigidly connected to opposing ends of the hollow tube.

12. The combustor housing of claim 11, wherein the container further includes a nut and a clevis pin rigidly connected to the hollow tube at a first opening and a second opening respectively.

13. The combustor housing of claim 11, wherein a cross section of the hollow tube is substantially square.

14. A gas turbine engine comprising:
a compressor system;
a plurality of injectors adapted to receive compressed air from the compressor system, the plurality of injectors further adapted to premix and supply fuel and air; and
a combustor housing including:
a combustor operatively connected to the plurality of injectors, the combustor configured to receive and combust the premixed fuel and air, wherein the combustor produces acoustic oscillations; and
a resonance damper for damping the acoustic oscillations within the combustor housing, the resonance damper including:
a container configured to be attached to an interior wall of the combustor housing and having a cavity;
an opening provided on the container; and
a pipe rigidly connected to the opening to define the resonance damper with the cavity.

15. The gas turbine engine of claim 14, wherein the resonance damper is positioned in a predetermined region of maximum dynamic pressure fluctuations within the combustor housing.

16. The gas turbine engine of claim 14, wherein the container is configured to be attached to the interior wall, at an anterior portion, of the combustor housing by fasteners.

17. The gas turbine engine of claim 14, wherein the pipe defines a throat configured to allow passage of the acoustic oscillations into the cavity.

18. The gas turbine engine of claim 14, wherein the container includes a hollow tube, a front plate, and a back plate, wherein the front plate and the back plate are rigidly connected to opposing ends of the hollow tube.

19. The gas turbine engine of claim 18, wherein the container further includes a nut and a clevis pin rigidly connected to the hollow tube at a first opening and a second opening respectively.

20. The gas turbine engine of claim 18, wherein a cross section of the hollow tube is substantially square.
